(19) United States
(12) Patent Application Publication
(10) Pub. No.: US 2008/0221279 A1
(43) Pub. Date: Sep. 11, 2008

(54) Process for the production of shape memory molded articles with a wide range of applications

(76) Inventors: Wolfgang Brauer, Leverkusen (DE); Joachim Wagner, Koln (DE); Helmut Meyer, Odenthal (DE)

Correspondence Address: BAYER MATERIAL SCIENCE LLC, 100 BAYER ROAD, PITTSBURGH, PA, 15205, US

(21) Appl. No.: 12/074,568

(22) Filed: Mar. 5, 2008

(30) Foreign Application Priority Data
Mar. 8, 2007 (DE) 102007011239.6

(51) Int. Cl. C08G 18/10

(52) U.S. Cl. 525/457

(57) ABSTRACT

The present invention relates to a process for the production of shape memory molded articles with a wide temperature application range, and their use in the he production of injection molded articles and extruded articles.

### FIELD OF THE INVENTION

The present invention relates to a process for the production of shape memory molded articles with a wide temperature application range, and their use.

### BACKGROUND OF THE INVENTION

Thermoplastic polyurethane elastomers (TPU) have been known for a long time, and are of technical importance on account of the combination of high-grade mechanical properties and the known advantages of their inexpensive thermoplastic processability. A large range of mechanical properties can be achieved by using different chemical synthesis components. A review of TPUs, their properties and applications is given for example in Kunststoffe 68 (1978), pp. 819 to 825, or Kautschuk, Gummi, Kunststoffe 35 (1982), pp. 568 to 584.

TPUs are synthesized from linear polyols, generally polyester or polyether polyols, organic diisocyanates and short-chained diols (chain extenders). In order to accelerate the formation reaction catalysts can additionally be added. In order to adjust the properties, the synthesis components can be varied in relatively broad molar ratios. Molar ratios of polyols to chain extenders of 1:1 to 1:12 have proved suitable. Products with a Shore A hardness of 60 to 75 are thereby produced.

The TPUs can be produced continuously or discontinuously. The best known technical production processes are the strip process (GB 1,057,018) and the extruder process (DE 1 964 834 and 2 059 570).

For example, the production of thermoplastically processable polyurethane elastomers with an improved processing behavior by means of plasticized block (segment) pre-extension is described in EP-A 0 571 830. The known starting compounds are employed. The TPUs thereby obtained have an improved stability and an improved demoldability in injection molding applications.

Shape memory materials are also generally known. In the article “Formgedächtnispolymere” (shape memory polymers) by A. Lendlein and S. Kelch, Angewandte Chemie, 2002, pp. 2138-2162, Wiley-VCH Publishers, in addition to other polymers polyurethanes are also described. Shape memory materials accordingly are materials that can alter their external shape under the action of an external stimulus. If the change in shape occurs on account of a change in temperature, this is a thermally induced shape memory effect. When using shape memory polymers for the production of these materials, a physical phase transition, for example a melting point of a phase, in the technically desired temperature range is employed for this purpose.

The shape memory polymers from polyurethanes described by Lendlein are made of components that are generally industrially unavailable or available only with difficulty, or they exhibit other disadvantages. Thus, polyurethanes, for example, often exhibit an undesirable mother-of-pearl effect or are too sensitive to hydrolysis.

The shape memory polymers described in DE-A 102 34 006 and DE-A 102 34 007 exhibit a phase transition that lies below body temperature and are therefore not suitable for numerous applications. In addition, in the technically important elastomer modulus range of 5-20 MPa these polyurethanes are significantly limited as regards their temperature application range. They already lose their dimensional stability at 100° to 120° C.

### SUMMARY OF THE INVENTION

The present invention provides shape memory polymers that have an elevated switching temperature and at the same time have a temperature application range of up to 180° C.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The present invention provides an improved process for the production of shape memory molded articles based on thermoplastically processable polyurethanes with a phase transition range of 25°-120° C., preferably 35°-70° C., and a hardness difference measured at a temperature below and above the phase transition temperature of >15 Shore A, which are thermally stable at temperatures above 120° C., the improvement involving, in a multi-stage reaction
a) reacting one or more linear hydroxyl-terminated polyols with molecular weights of 2,000 to 4,000 g/mole and a functionality of 2 with a first portion of an organic diisocyanate in a NCO:OH molar ratio of 1.1:1 to 1.9:1 to form an isocyanate-terminated prepolymer,
b) mixing the prepolymer produced in stage a) is mixed with the remaining (second) portion of the organic diisocyanate,
c) reacting the mixture produced in stage b) with one or more diol chain extenders with molecular weights of 60 to 350 g/mole to form a thermoplastic polyurethane,

wherein after the stage c) a NCO:OH molar ratio is adjusted to 0.9:1 to 1.1:1, and wherein the molar ratio of diol chain extenders to polyol is 3:1 to 1:2.

Suitable organic diisocyanates that may be used are for example aliphatic, cycloaliphatic, araliphatic, heterocyclic and aromatic diisocyanates, as are described for example in Justus Liebigs Annalen der Chemie, 562, pp. 75 to 136.

In particular, the following diisocyanates may be mentioned by way of example: aliphatic diisocyanates such as hexamethylene diisocyanate, cycloaliphatic diisocyanates such as isophorone diisocyanate, 1,4-cyclohexane diisocyanate, 1-methyl-2,4-cyclohexane diisocyanate and 1-methyl-2,6-cyclohexane diisocyanate as well as the corresponding isomer mixtures, 4,4′-dicyclohexylmethane diisocyanate, 2,4′-dicyclohexylmethane diisocyanate and 2,2′-dicyclohexyl-methane diisocyanate as well as the corresponding isomer mixtures, aromatic diisocyanates such as 2,4-toluylene diisocyanate, mixtures of 2,4-toluylene diisocyanate and 2,6-toluylene diisocyanate, 4,4′-diphenylmethane diisocyanate, 2,4′-diphenylmethane diisocyanate and 2,2′-diphenylmethane diisocyanate, mixtures of 2,4′-diphenylmethane diisocyanate and 4,4′-diphenylmethane diisocyanate, urethane-modified liquid 4,4′-diphenylmethane diisocyanates or 2,4′-diphenylmethane diisocyanates, 4,4′-diisocyanatodiphenylethane-(1,2) and 1,5-naphthylene diisocyanate. Preferably 1,6-hexamethylene diisocyanate, 1,4-cyclohexane diisocyanate, isophronoe diisocyanate, dicyclohexylmethane diisocyanate, diphenylmethane diisocyanate isomer mixtures with a 4,4′-diphenylmethane diisocyanate content of more than 96 wt. %, 4,4′-diphenyl-methane diisocyanate and 1,5-naphthylene diisocyanate are used. The aforementioned diisocyanates can be used individually or in the form of mixtures with one another. They may also be used together with up to 15 mole % (calculated on the total diisocyanate) of a polyisocyanate, though only so much polyisocyanate can be added that a still thermoplastically processable product is formed. Examples of polyisocyanates are triphenylmethane-4,4′,4″-triisocyanate and polyphenylpolymethylene polyisocyanates.

Linear hydroxyl-terminated polyols are used as polyols. Depending on the production these often contain small amounts of non-linear compounds. One therefore often also speaks of “substantially linear polyols”.

Suitable polyols are for example polyether diols and polyester diols.

Polyether diols can be produced by reacting one or more alkylene oxides containing 2 to 4 carbon atoms in the alkylene radical with a starter molecule that contains two active hydrogen atoms in bound form. The following for example may be mentioned as alkylene oxides: ethylene oxide, 1,2-propylene oxide, epichlorohydrin and 1,2-butylene oxide and 2,3-butylene oxide. It is preferred to use ethylene oxide, propylene oxide and mixtures of 1,2-propylene oxide and ethylene oxide. The alkylene oxides may be used individually, in an alternating manner, or as mixtures. Suitable starter molecules are for example water, amino alcohols such as N-alkyl-diethanolamines, for example N-methyl-diethanolamine, and diols such as ethylene glycol, 1,3-propylene glycol, 1,4-butanediol and 1,6-hexanediol. Optionally mixtures of starter molecules may also be used. Suitable polyether diols are furthermore the polymerization products of tetrahydrofuran containing hydroxyl groups. There may also be used trifunctional polyethers in amounts of 0 to 30 wt. %, referred to the bifunctional polyether, but at most in such an amount that a still thermoplastically processable product is formed. The substantially linear polyether diols preferably have number average molecular weights M̅ₙ of 2,000 to 4,000.

Polyester diols may for example be produced from dicarboxylic acids with preferably 2 to 12 carbon atoms, more preferably 4 to 6 carbon atoms, and polyhydric alcohols. Suitable dicarboxylic acids are for example aliphatic dicarboxylic acids such as succinic acid, glutaric acid, adipic acid, suberic acid, azelaic acid and sebacic acid, or aromatic dicarboxylic acids such as phthalic acid, isophthalic acid and terephthalic acid. The dicarboxylic acids may be used individually or as mixtures, for example in the form of a succinic acid, glutaric acid and adipic acid mixture. For the production of the polyester diols it may possibly be advantageous to use, instead of the dicarboxylic acids, the corresponding dicarboxylic acid derivatives such as carboxylic acid diesters containing 1 to 4 carbon atoms in the alcohol radical, carboxylic acid anhydrides or carboxylic acid chlorides. Examples of polyhydric alcohols are glycols containing 2 to 10, preferably 2 to 6 carbon atoms, for example ethylene glycol, diethylene glycol, 1,4-butanediol, 1,5-pentanediol, 1,6-hexanediol, 1,10-decanediol, 2,2-dimethyl- 1,3-propanediol, 1,3-propanediol or dipropylene glycol. Butanediol adipates are particularly preferred.

Also suitable are esters of carbonic acid with the aforementioned diols, in particular those containing 4 to 6 carbon atoms, such as 1,4-butanediol or 1,6-hexanediol, condensation products of ω-hydroxycarboxylic acids such as ω-hydroxycaproic acid, or polymerization products of lactones, for example optionally substituted ω-caprolactones.

The polyester diols preferably have according to the invention number average molecular weights Mₙ of 2,000 to 4,000.

As chain extenders there are used diols, optionally mixed with small amounts of diamines, with a molecular weight of 60 to 350, preferably aliphatic diols with 2 to 14 carbon atoms, such as for example ethanediol, 1,6-hexanediol, diethylene glycol, dipropylene glycol, ethylene glycol and, in particular, 1,4-butanediol. Also suitable however are diesters of terephthalic acid with glycols containing 2 to 4 carbon atoms, for example terephthalic acid bis-ethylene glycol or terephthalic acid bis-1,4-butanediol, hydroxyalkylene ethers of hydroquinone, for example 1,4-di(β-hydroxyethyl)-hydroquinone, ethoxylated bisphenols, for example 1,4-di(β-hydroxyethyl)-bisphenol A. Ethanediol, 1,4-butanediol, 1,6-hexanediol, 1,4-di(β-hydroxyethyl)-hydroquinone or 1,4-di(β-hydroxyethyl)-bisphenol A are preferably used as chain extenders. Mixture of the chain extenders mentioned above may also be used. In addition small amounts of triols may also be added.

Furthermore, monofunctional compounds may also be added in minor amounts, for example as chain terminators or mold release auxiliaries. Alcohols such as octanol and stearyl alcohol or amines such as butylamine and stearylamine may be mentioned by way of example.

For the production of the TPUs the synthesis components, optionally in the presence of catalysts, auxiliary substances and/or additives, can be reacted in such amounts that the equivalence ratio of NCO groups to the total amount of NCO-reactive groups is preferably 0.9:1.0 to 1.1:1.0, more preferably 0.95:1.0 to 1.10:1.0.

Suitable catalysts according to the invention are the tertiary amines known to those skilled in the art, such as for example triethylamine, dimethylcyclohexyl-amine, N-methylmorpholine, N,N′-dimethylpiperazine, 2-(dimethylamino-ethoxy)ethanol, diazabicyclo[2,2,2]octane and the like, as well as in particular organometallic compounds such as titanic acid esters, iron compounds or tin compounds such as tin diacetate, tin dioctoate, tin dilaurate or the tin dialkyl salts of aliphatic carboxylic acids, such as dibutyltin diacetate or dibutyltin dilaurate or the like. Preferred catalysts are organometallic compounds, in particular titanic acid esters, iron compounds and tin compounds. The total amount of catalysts in the TPUs is preferably 0 to 5 wt. %, more preferably 0 to 1 wt. %, based on the weight of the TPU.

In addition to the TPU components and the catalysts, auxiliary substances and/or additives may also be added. The following may be mentioned by way of example: lubricants such as fatty acid esters, their metal soaps, fatty acid amides, fatty ester amides and silicone compounds, anti-blocking agents, inhibitors, stabilizers against hydrolysis, light, heat and discoloration, flameproofing agents, dyes, pigments, inorganic and/or organic fillers and reinforcing agents. Reinforcing agents are in particular fibrous reinforcing substances such as for example inorganic fibers, which are produced according to the prior art and may also be treated with a sizing agent. Preferably nanoparticulate solids, such as for example carbon black, may also be added in amounts of 0-10 wt. % to the TPUs. Further details concerning the known auxiliary substances and additives can be obtained from the specialist literature, for example the monograph by J. H. Saunders and K. C. Frisch “High Polymers”, Vol. XVI, Polyurethane, Parts 1 and 2, Verlag Interscience Publishers 1962 and, 1964, the Handbook of Plastics Additives by R. Gächter and H. Müller (Hanser Verlag Munich 1990) or from DE-A 29 01 774.

Further additives which may be incorporated into the TPU include thermoplastic materials, for example polycarbonates and acrylonitrile/butadiene/styrene terpolymers, in particular ABS. Other elastomers such as rubber, ethylene/vinyl acetate copolymers, styrene/butadiene copolymers as well as other TPUs may also be employed. Commercially available plasticizers such as phosphates, phthalates, adipates, sebacates and alkylsulfonic acid esters are furthermore suitable for incorporation.

The TPU is produced in a multi-stage process.

The amounts of the reaction components for the prepolymer production of stage a) are chosen so that the NCO/OH ratio of organic diisocyanate to polyol in stage a) is preferably 1.1:1 to 1.9:1, more preferably 1.1:1 to 1.7:1.

The components are thoroughly mixed with one another and the prepolymer reaction of stage a) is preferably carried out to a substantially complete conversion (referred to the polyol component).

The remaining amount of diisocyanate is then mixed in (stage b).

Following this the chain extender is intensively mixed in and the reaction is brought to completion (stage c).

The molar ratio of diol chain extender to polyol is preferably 3:1 to 1:2. The molar ratio of the NCO groups to the OH groups as a whole over all stages is adjusted to 0.9:1 to 1.1:1. Preferably the molar ratio of diol chain extender to polyol is less than 2:1 if the polyol has a molecular weight of 2,000, and is less than 3:1 if the polyol has a molecular weight of 4,000.

The TPU can be produced discontinuously or continuously. The best known industrial production processes are the strip process (GB-A 1 057 018) and the extruder process (DE-A 1 964 834, DE-A 2 059 750 and U.S. Pat. No. 5,795,948).

The known mixing devices, preferably those that operate with a high shear energy, are suitable for the production of the TPUs. For continuous production, there may be mention by way of example co-kneaders, preferably extruders, such as for example twin screw extruders and BUSS kneaders.

The TPU can be produced for example in a twin screw extruder, by producing the prepolymer in the first part of the extruder, followed by the addition of the diisocyanate and the chain extension in the second part. In this connection, the addition of the diisocyanate and chain extender may take place in parallel in the same metering opening of the extruder, or preferably in succession in two separate openings. According to the invention, the metering of the chain extender must however not take place before the metering of the further diisocyanate.

The prepolymer can however also be produced outside the extruder, in a separate, upstream connected prepolymer reactor, discontinuously in a vessel, or continuously in a tube equipped with static mixers, or in a stirred tube (tubular mixer).

A prepolymer produced in a separate prepolymer reactor can however also be mixed by means of a first mixing apparatus, for example a static mixer, with the diisocyanate, and by means of a second mixing apparatus, for example a mixing head, with the chain extender. This reaction mixture is then, similarly to the known strip process, added continuously to a carrier, preferably a conveyor belt, where it is reacted until the material solidifies, if necessary while heating the strip, to form the TPU.

The TPUs produced by the process according to the invention have an additional phase transition preferably in the temperature range from 25° to 120° C. A broad application range of up to 180° C. (melting point of the hard blocks) for elastomeric properties is however still available above the phase transition.

After a thermoplastic processing to form the molded article, preferably an injection molded article or an extruded article (such as for example profiled sections and hoses), these molded articles exhibit shape memory properties.

The shape memory properties may be utilized, for example, by stretching the article from the permanent shape at a temperature greater than or equal to the switching temperature and lower than the melting point of the hard block, and cooling the article in the stretched shape to a temperature lower than the switching temperature. Due to the cooling the TPU is fixed in the stretched, temporary shape, and transforms into the previous permanent shape only on heating above or at a temperature equal to the switching temperature.

The shape memory articles produced by the process according to the invention are used for the production of injection molded parts, such as for example thermally controlled actuating devices or thermally controllably mountable or demountable structural parts, for example closure systems of pipes and vessels, temperature sensors, e.g. for fire valves and smoke detectors, artificial muscles, self-degrading securing elements such as bolts, screws, rivets, etc., seals, end flaps, sleeves, hose and pipe clips, securing rings, couplings, bushings, clamping discs, elastic bearings, plugs, linear drives, conversion shafts and action figures.

Extruded articles such as heat-shrinking sheets, films and fibers, temperature fuses and sensors, catheters, implants, cardiovascular stents, heat-shrinking bone replacements and surgical suture material can also be made from the shape memory articles.

### EXAMPLES

The present invention is further illustrated, but is not to be limited, by the following examples. All quantities given in “parts” and “percents” are understood to be by weight, unless otherwise indicated.

Production of the TPUs:

In each case, a polyol was placed in a reaction vessel according to Table 1. After heating the contents to 180° C., the partial amount 1 of the 4,4′-diphenylmethane diisocyanates (MDI) was added while stirring and the prepolymer reaction was carried out to a conversion of more than 90 mol %, referred to the polyol.

After completion of the reaction, the partial amount 2 of the MDI was added while stirring. The amount of chain extender specified in Table 1 was then added, the NCO/OH ratio of all components being 1.00. After intensive mixing the TPU reaction mixture was poured onto a metal sheet and heated for 30 minutes at 120° C.

TABLE 1

| | | | MDI | MDI | | |
|---|---|---|---|---|---|---|
| | | Polyol | partial | partial | | Chain |
| Exam- | Poly- | amount | amount 1 | amount 2 | Chain | extender |
| ple | ol | (mols) | (mols) | (mols) | extender | (mols) |
| 1* | 1 | 1 | 1.50 | 2.7 | 1 | 3.20 |
| 2 | 1 | 1 | 1.25 | 0.55 | 1 | 0.80 |
| 3 | 1 | 1 | 1.25 | 1.05 | 1 | 1.30 |
| 4 | 2 | 1 | 1.50 | 1.70 | 1 | 2.20 |
| 5 | 2 | 1 | 1.25 | 1.35 | 2 | 1.60 |

*comparison example not according to the invention
Polyol 1 = DESMOPHEN PE 225 B (from Bayer MaterialScience AG: butanediol adipate; molecular weight 2,200)
Polyol 2 = DESMOPHEN PE 400 B (from Bayer MaterialScience AG: butanediol adipate; molecular weight 4,000)
Chain extender 1 = 1,4-butanediol
Chain extender 2 = 1,4-di(β-hydroxyethyl)-hydroquinone

The casting plates were cut up and granulated. The granulate was melted in a D 60 (32-screw) injection molding machine from the Mannesmann Company and formed into S1 rods (forming temperature: 40° C.; rod size: 115×25/6×2) and plates (forming temperature 40° C.; size: 125×50×2 mm).

Measurements

The hardness was measured according to DIN 53505 at room temperature and at 60° C. (Table 2).

Dynamic Mechanical Analysis (DMA According to ISO 6721.4: Storage-Tensile Modulus of Elasticity)

Rectangular sections (30 mm×10 mm×2 mm) were punched out from the injection molded plates. These test plates were periodically excited with very small deformations under a constant initial load—possibly dependent on the storage modulus—and the force acting on the clamped article was measured as a function of the temperature and excitation frequency.

The additionally applied initial load served to hold the sample in a still sufficiently clamped state at the time of negative deformation amplitude.

The DMA measurements were carried out with a Seiko DMS model 6100 instrument at 1 Hz in the temperature range from −150° C. to 200° C. at a heating rate of 2° C. per minute.

In order to characterize the behavior of the shape memory article in the range of the desired phase transition (switching temperature), the storage-tensile modulus of elasticity was measured and recorded at 20° C. and at 60° C. for purposes of comparison.

The switching temperature was given as the turning point of the phase transition (Table 2).

The temperature of the DMA curve at which the modulus curve falls below the value 2 MPa was given as a measure of the thermal stability.

Thermally Induced Deformation (TID)

A S1 rod was stretched to 100% at 60° C. (temperature greater than the switching temperature) and cooled, still extended, to room temperature. The molded article is thereby fixed in the stretched temporary shape (length 1 in percent of the initial length).

By renewed heating above the switching temperature, a shrinkage back to the permanent shape was triggered (length 2 in percent of the initial length).

TABLE 2

| | | | | | | | DMA T | DMA |
|---|---|---|---|---|---|---|---|---|
| | Hardness at | Hardness | TID | TID | DMA E′ | DMA E′ | at | switching |
| Ex. | room temp. | at 60° C. | length 1 | length 2 | (20° C.) | (60° C.) | [2 MPa] | temp. |
| No. | [Shore A] | [Shore A] | [%] | [%] | [MPa] | [MPa] | [° C.] | [° C.] |
| 1* | 89 | 86 | 130 | 106 | 67 | 48 | 176 | None |
| 2 | 94 | 58 | 186 | 103 | 268 | 11 | 123 | 42 |
| 3 | 93 | 68 | 169 | 103 | 162 | 16 | 151 | 43 |
| 4 | 95 | 62 | 198 | 102 | 399 | 15 | 142 | 49 |
| 5 | 96 | 66 | | | 368 | 16 | 158 | 42 |

*comparison example not according to the invention

In the case of the shape memory molded articles according to the invention the additional phase transition (see switching temperature) generated by the production method according to the invention can be seen in the DMA measurement, which leads to a significant change in hardness and modulus. For the technically important modulus range from 5 to 30 MPa, a broad temperature application range up to 160° C. is nevertheless obtained, which is characterized by the temperature at 2 MPa.

The shape memory properties are illustrated by the figures for the lengths at the thermally induced deformation (TID). Whereas in comparison Example 1 there is hardly any thermally induced change in length on account of the absence of the transition point, in the case of the Examples 2 to 5 according to the invention a significant change in length is triggered.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. In a process for the production of shape memory molded articles based on thermoplastically processable polyurethanes with a phase transition range of about 25° to about 120° C. and a hardness difference measured at a temperature below and above the phase transition temperature of >15 Shore A, which are thermally stable at temperatures above about 120° C., the improvement comprising in a multi-stage reaction:
a) reacting one or more linear hydroxyl-terminated polyols with molecular weights of about 2,000 to about 4,000 g/mole and a functionality of 2 with a first portion of an organic diisocyanate in a NCO:OH molar ratio of about 1.1:1 to about 1.9:1 to form an isocyanate-terminated prepolymer,
b) mixing the prepolymer produced in stage a) with the remaining second portion of the organic diisocyanate,
c) reacting the mixture produced in stage b) with one or more diol chain extenders with molecular weights of about 60 to about 350 g/mole to form a thermoplastic polyurethane,
wherein after the stage c), the NCO:OH molar ratio is adjusted to about 0.9:1 to about 1.1:1, and wherein the molar ratio of diol chain extenders to polyol is about 3:1 to about 1:2.

2. The process according to claim 1, wherein the hydroxyl-terminated polyol is a butylene adipate with a mean molecular weight of about 2,000 to about 4,000 g/mol.

3. The process according to claim 1, wherein the organic diisocyanate is selected from the group consisting of 4,4′-diphenylmethane diisocyanate, isophorone diisocyanate, dicyclohexylmethane-4,4-diisocyanate, toluylene-2,4-diisocyanate, 1,6-hexamethylene diisocyanate and 1,5-naphthylene diisocyanate.

4. The process according to claim 1, wherein the diol chain extender is selected from the group consisting of ethanediol, 1,4-butanediol, 1,6-hexanediol, 1,4-di(β-hydroxyethyl)-hydroquinone and 1,4-di(β-hydroxyethyl)-bisphenol A.

5. The process according to claim 1, wherein from about 0 to about 10 wt. % of a nanoparticulate solid is added to the mixture during the production or processing.

6. The process according to claim 5, wherein the nanoparticulate solid is carbon black.

7. The process according to claim 1, wherein the shape memory molded articles are produced by injection molding processing or extrusion processing.

8. In a process for the production of injection molded articles and extruded articles, the improvement comprising including the shape memory molded articles produced according to claim 1.

9. The process according to claim 1, wherein the phase transition range of the thermoplastically processable polyurethanes is from about 35° to about 70° C.
